(19) United States
(12) Patent Application Publication
(10) Pub. No.: US 2019/0332777 A1
(43) Pub. Date: Oct. 31, 2019

(54) TRUSTED COMPUTING INTEGRITY MEASUREMENT ARCHITECTURE SECURITY FOR CONTAINERS

(71) Applicant: Hewlett Packard Enterprise Development LP, Houston, TX (US)

(72) Inventors: Nigel Edwards, Bristol (GB); Guilherme De Campos Magalhaes, Porto Alegre (BR); Joaquim Gomes da Costa Eulalio De Souza, Guaiba (BR)

(21) Appl. No.: 15/966,423

(22) Filed: Apr. 30, 2018

(51) Int. Cl. G06F 21/57; H04L 9/32; H04L 9/14; G06F 17/30

(52) U.S. Cl. CPC G06F 21/577; H04L 9/3247; G06F 2221/034; G06F 17/30109; H04L 9/14

(57) ABSTRACT

A trusted computing integrity measurement architecture (IMA) security method may include receiving a command to carry out an event for a container with respect to a file of the container, the container being identified by a namespace, measuring the file to produce a measurement value for the file and storing the measurement value, an identification of the file and the namespace in an entry of an IMA log.

### BACKGROUND

Trusted Computing is a technology for assuring the system will behave as it is intended. Trusted Computing may utilize integrity measurement architecture (IMA) employed in an operating system kernel to measure content of files prior to be executed, wherein the measurement values, often hashes, are stored in an immutable log and in a hardware enforced Root of Trust Trusted Platform Module (TPM). The immutable log facilitates analysis of subsequent security breaches where a remote system verifies if the measured hashes correspond to expected file states.

### BRIEF DESCRIPTION OF THE DRAWINGS

FIG. 1 is a schematic diagram illustrating portions of an example trusted computing integrity measurement architecture system.

FIG. 2 is a flow diagram of an example trusted computing integrity measurement architecture method.

FIG. 3 is a schematic diagram illustrating portions of an example trusted computing integrity measurement architecture system.

FIG. 4 is a flow diagram of an example trusted computing integrity measurement architecture method.

FIG. 5 is a schematic diagram illustrating portions of an example trusted computing integrity measurement system.

FIG. 6 is a diagram illustrating portions of an example trusted computing integrity measurement architecture system 600.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed herein are trusted computing IMA systems and methods that support containerized applications, referred to as containers. Containers comprise files and applications grouped based upon a user space process carried out by such files and applications. Such containers are identified by what is referred to as a container namespace. Namespaces are a kernel feature in the Linux operating system that isolates system resources for a subset of processes. Examples of name spaces include, but are not limited to, process IDs, host names, user IDs, network stack, inter-process communication and filesystem mount points. For the purposes of this disclosure, unless otherwise specifically indicated, a “container namespace” refers to the filesystem mount point namespace that is unique to the container.

Such containers may run under a view of a completely separated operating system such that they may be seen as individual systems, running under different user configurations and security requirements in a multi-tenancy environment. Although such containers may share files, the expected file state may be different for each container. Such containers may be generated by commercially available container engine such as Docker, CoreOS rkt or LXC.

The disclosed trusted computing IMA systems and methods facilitate the identification of the container origin of file events so as to distinguish between file integrity measurements in the IMA log for different containers. Such file events comprise a command or request by a container for access to a particular file/application (hereinafter referred to as a “file”). Such access may be to execute the file or read the file. Identifying the container from which a file event originated, such as the container from which a command to execute a file originated, facilitates the subsequent identification of the container where a particular file event, such as a particular operating system attack, may have occurred.

For individual file events, the IMA system may take a measurement of the content of the file to be executed pursuant to a file event command as part of a container. Such a measurement often comprises a hash of the file content. This hash is stored in an IMA log as part of an entry for the individual file event. The entry for the file event may additionally include a file identification, such as a pathname for the file. The IMA log is specifically utilized as part of the trusted computing system to verify the integrity of the file.

The disclosed trusted computing IMA systems and methods facilitate the identification of the container origin of a file event by storing additional fields in the file event entry of the IMA log that uniquely identify or differentiate containers. In one implementation, the disclosed trusted computing IMA systems and methods store the container namespace in the entry of the IMA log for the file event.

In some systems, the namespace or namespace ID is released when a container exits or terminates such as the namespace may be reused by a new container. In other words, a given namespace ID is attached a first container during the life of the first container. The same given namespace ID may be subsequently attached to a second different container. To associate a particular container to a particular file event based on the recorded namespace ID in the file event entry of the IMA log when two or more containers may have utilized the same namespace ID, the user space of such systems also tracks a period of time a container was attached to a specific namespace such that each namespace ID in the file event entries of the IMA log may be mapped to its originating container.

In one implementation, the disclosed trusted computing IMA systems and methods may additionally store a timestamp for the file event in a timestamp field of the entry for the file event in the IMA log. In such a system, a record may be kept of those time periods that a particular container was using or was assigned a particular namespace. In such a manner, the particular container from which a particular file event originated may be identified despite usage of a particular namespace ID by multiple containers.

In one implementation, such systems may additionally or alternatively track the number of file events in the IMA log when a particular container is started. In such a system, a record indicating the number of file events initiated by the container may be kept for each container. In such a manner, the particular container from which a particular file event originated may be identified despite usage of a particular namespace ID by multiple containers.

The disclosed trusted computing IMA systems and methods facilitate customized container specific IMA security or integrity policies. The container specific IMA integrity policies define what files are to be measured, audited and appraised on a container-by-container basis. For example, a container verification policy store may direct a file to be measured for the IMA log, such as the generation of a hash of the contents of the file for the IMA log, when the file is being accessed by a first container. The container verification policy store may alternatively indicate that the same file is not to be measured for the IMA log when being accessed by second different container. In some implementations, the container verification policy or verification policy store may additionally vary depending upon the type of access to the file being requested by a particular container. As a result, each process running inside of its respective container may follow its own IMA policy, completely independent of other processes running inside of other respective containers.

In one implementation, the operating system may keep a policy store comprising an updated list of running container namespaces, mapping each namespace ID to its corresponding policy or policy rules. The IMA policy defined for a particular container is automatically extended to any new namespace created inside that container until a specific policy is defined for the new namespace. The process in running inside a container has no permission to set policy to other containers, unless a hierarchy relationship among the source and the target name spaces is provided. When a process is writing rules to a security policy file, the operating system may detect the user space process namespace in order to know to which container the new policy should be attached.

In some implementations, the operating system additionally comprises a key ring store which assigns key rings in a container-specific manner. The IMA system may support digital signatures for immutable files, storing the digital file signature along with the file hash measuring the file may involve generating and RSA private/public key pair. The key generation may be anchored on a trusted platform module (TPM) and stored in kernel memory using a key storage mechanism called a key ring. Different containers may utilize different sets of keys, different or separate key rings for each namespace. Because each container or namespace ID may be assigned a distinct IMA policy (per above) digital file signature usage may be specific per container.

The disclosed trusted computing IMA systems and methods may be provided as part of an overall trusted computing IMA security system which comprises a TPM chip and a remote challenging system. In operation, the operating system creates a hash of each file event log entry, as the file entries are being made in the IMA log. The hash of the file event log entry is communicated to the TPM chip, the TPM chip comprises platform configuration registers (PCRs) that comprise the file event log entry hashes. The PCR cannot be reset while the system is running, it is only possible to “extend” the current value with a new hash. The TPM chip combines the new hash with the existing PCR value to create a new value which is stored in the PCR. In this way the old value cannot erased.

The remote challenging system asynchronously verifies the accuracy or integrity of the current IMA log and the files. On a periodic or undefined basis, the remote challenging system receives the PCR values from the TPM chip and also receives the current IMA/TPM log. The remote challenging system compares the PCR values with respect to the IMA log entries to verify the integrity of the current IMA/TPM log. In particular, in one implementation, the remote challenging system performs the same hash on each entry of the current IMA/TPM log as was additionally applied during the generation of the PCR values stored on the TPM chip. The remote challenging system compares the PCR values from the TPM chip to the past file event entries of the current IMA log to confirm or verify integrity of the current IMA log.

Upon verification of the IMA log, the remote challenging system compares the measurement values for the file in each of the file event entries of the IMA log to predefined or predefined measurement values for valid versions of the same file. In one implementation, the challenge system may include a store or memory containing “known good hashes” which are hashes of valid versions of various files that may be accessed by the various containers. The hashes of the “known good hashes” are the same hashes as applied to the file content as stored in the file event entry of the IMA log. A file event entry log having a file content measurement value (hash value) that matches the file content measurement value (hash value) of a valid version of the file stored or retrieved by the remote challenging system may be deemed to be uncorrupted or as having integrity. In contrast, a file event entry log having a file content measurement value (hash value) that does not match the file content measurement value (hash value) of a valid version of the same file stored or treated by remote challenging system may be deemed to have been corrupted. The stored name spaces in the IMA log may then be utilized by the attesting system, the remote challenging system or other integrity auditing systems to identify the container where the particular file may have been attacked or corrupted.

Disclosed herein is an example trusted computing integrity measurement architecture (IMA) security method may include receiving a command to carry out an event for a container with respect to a file of the container, the container being identified by a namespace, measuring the file to produce a measurement value for the file and storing the measurement value, an identification of the file and the namespace in an entry of an IMA log.

Disclosed herein is an example trusted computing integrity measurement architecture (IMA) security method that may include receiving a command to carry out an event for a container with respect to a file of the container, the container being identified by a namespace, accessing a lookup table comprising different measurement policies for different containers. The different measurement policies for different containers may include instructions to measure the file in response to the event being carried out for the container and instructions to not measure the file in response to the event being carried out for a second container. The example method may further include retrieving a measurement policy for the container and measuring the content of the file in accordance with the measurement policy to produce a measurement value.

Disclosed herein is an example trusted computing integrity measurement architecture (IMA) security system that may include containers, an IMA log, a processing unit in a measurement module. Each container may comprise a process built upon containerized files and designated by a namespace. The IMA log may comprise file event entries, wherein each entry includes a file identification field, a file content field and a namespace field. The measurement module may comprise a non-transitory computer-readable medium containing instructions to direct the processing unit to: receive a command to carry out an event for one of the containers with respect to a file of the container; measure the file to produce a measurement value for the file; and store the measurement value, an identification of the file and the namespace in an entry of an integrity measurement architecture (IMA) log.

FIG. 1 is a schematic diagram illustrating portions of an example trusted computing integrity measurement architecture (IMA) security system 20. System 20 facilitates the identification of the container origin of file events so as to distinguish between file integrity measurements in the IMA log for different containers. Such file events comprise a command or request by a container for access to a particular file/application (hereinafter referred to as a “file”). Such access may be to execute the file or read the file. Identifying the container from which a file event originated, such as the container from which a command to execute a file originated, facilitates the subsequent identification of the container where a particular file event, such as a particular operating system attack, may have occurred. System 20 comprises containers 30-1, 30-2 (collectively referred to as containers 30) and a security subsystem 32 comprising IMA log 40, processing unit 44 and measurement module 50.

Containers 30 are identified by what is referred to as a container namespace. Containers 30 may run under a view of a completely separated operating system such that they may be seen as individual systems, running under different user configurations and security requirements in a multi-tenancy environment. Although such containers 30 may share files, the expected file state may be different for each container. Such containers 30 may be generated by commercially available container engine such as Docker, CoreOS rkt or LXC.

IMA log 40 comprises a memory log provided as part of a non-transitory computer-readable medium for tracking and recording file events. IMA log 40 may be part of a Linux integrity kernel of a Linux operating system. As schematically shown by FIG. 1, IMA log 40 may comprise a table or other memory architecture storing a series of individual file event entries 54-1, 54-2, 54-n (collectively referred to as entries 54). Each of entries 54 may comprise a file event entry identification field 56, a file ID field 58, a file content field 60 and a container namespace ID field 62, amongst others.

File event entry field 56 is to contain values or data identifying the file event. In some implementations, file event entry field 56 may be omitted, where the entries are in an ordered fashion so as to distinguish one file event from another.

File ID field 58 comprises a memory field to contain values or data identifying the file associated with the file event or file event command received during execution of a process inside a particular container. In one implementation, the file ID field is to store a file ID in the form of a pathname of the particular file.

File content field 60 comprise a memory field to store a measurement of the contents of the particular file of the file event. In one implementation, the file content field 62 store a measurement in the form of a hash of the contents of the file. As used herein, a “cryptographic hash function” may be a function comprising machine-readable instructions. The cryptographic hash function may include machine-readable instructions that, when executed by a processor, may receive an input. The cryptographic hash function may then generate a hexadecimal string to match the input. For example, the input may include a string of data (for example, the data structure in memory denoted by a starting memory address and an ending memory address). In such an example, based on the string of data the cryptographic hash function outputs a hexadecimal string. Further, any minute change to the input may alter the output hexadecimal string. In another example, the cryptographic hash function may be a secure hash function (SHA), any federal information processing standards (FIPS) approved hash function, any national institute of standards and technology (NIST) approved hash function, or any other cryptographic hash function.

Container namespace ID field 62 comprise the memory field of a file event entry 54 of log 40 that is to store a value or data indicating a container namespace ID. As discussed above, the container namespace ID identifies the container which issued the file event command which triggered the creation of the file event entry.

Processing unit 44 comprises at least one processor to carry out instructions provided by measurement module 50. Measurement module 50 comprises a non-transitory computer-readable medium forming a software-based module providing processing unit 44 with instructions to measure the content of files to be accessed pursuant to a file event command from a container. In other implementations, measurement module 50 may comprise an integrated circuit based module or combinations of a software-based module and the circuit-based module.

The instructions further direct the processing unit to populate the various fields for each file event as the file event commands are received. For each file event entry corresponding to a file event command, the instructions direct the processing unit to store the container namespace ID of the container that issued the file event command triggering the file event entry in the field 62 of the respective file event entry 54. In one implementation, measurement module 50 also populates other fields of each file event entry 54 of IMA log 40 with the designated data.

By storing the container namespace ID of the container that issued the file event command that triggered the file event entry in the file event entry of the IMA log, the subsequent identification of the container origin of the file event may be identified so as to distinguish between file integrity measurements in the IMA log for different containers. Identifying the container 30 from which a file event originated, such as the container 30 from which a command to execute a file originated, facilitates the subsequent identification of the container 30 where a particular file event, such as a particular operating system attack, may have occurred.

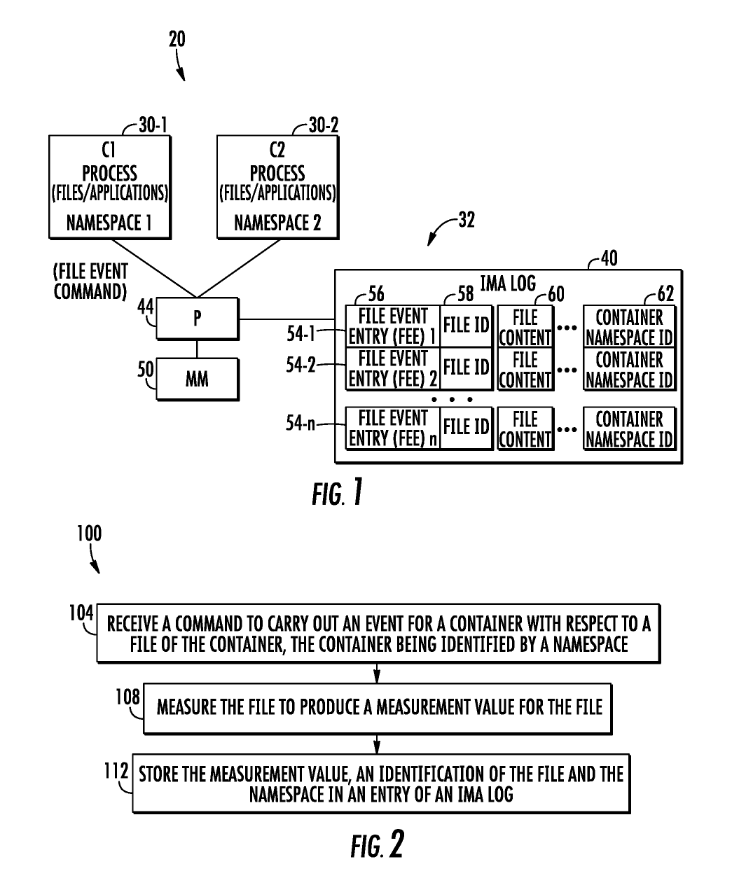

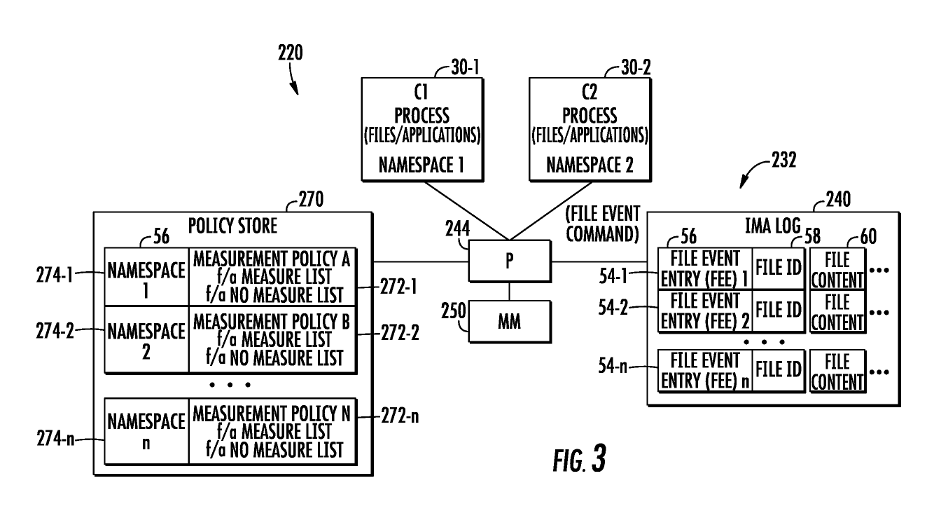

FIG. 2 is a flow diagram of an example trusted computing IMA security method 100 that may be carried out by system 20. Method 100 stores the namespace of the container from which a file event command was received such that a file event entry in the IMA log may be subsequently mapped to the container to identify and what container or process an operating system attack may have occurred. It should be appreciative that method 100 may likewise be carried out with any of the disclosed systems or with other similar systems.

As indicated by block 104, the integrity subsystem 32 receives a file event command, a command to carry out an event for a container with respect to a file of the container. The container is identified or associated with a designated namespace. The command may be to access the file such as to execute the file or read the file as part of the process of the container.

As indicated by block 108, measurement module 50 may direct processing unit 44 to measure the file to produce a measurement value for the contents of the file. In one implementation, the measurement value may be a hash of the contents of the file. In other implementations, the measurement value may comprise other measurements of the contents of the file.

As indicated by block 112, measurement module 50 directs processing unit 44 to store the measurement value, and identification of the file and the namespace of the container in an entry of an IMA log. In one implementation, the identification of the file may comprise a pathname of the file. In some implementations, measurement module may direct processing unit 44 to store additional data such a populate other fields of IMA log 40 with designated data. As discussed above, the additional storing of the namespace of the container in the entry of the IMA log may facilitate subsequent integrity auditing of the file and the identification of the particular container where an operating system attack may have occurred.

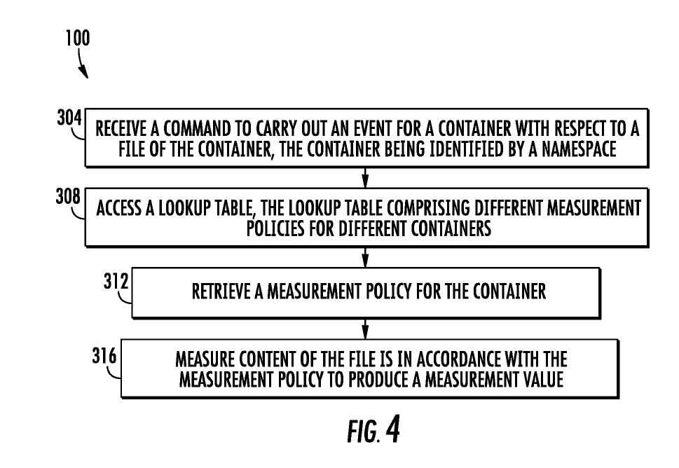

FIG. 3 schematically illustrates portions of an example trusted computing integrity measurement architecture (IMA) security system 220. System 220 facilitates customized container specific IMA security or integrity policies. System 220 comprises containers 30 as described above. System 220 further comprises a security subsystem 232 which comprises IMA log 240, processing unit 244, measurement module 250 and container policy store 270.

IMA log 240 is similar to IMA log 40 described above except that the field event entries 54 of IMA log 240 may omit container namespace ID field 62. In some implementations, IMA log 240 may have entries 54 that additionally comprise the container namespace ID field 62.

Processing unit 244 is similar processing unit 44 described above. Processing unit 244 carries out instructions provided in measurement module 250. Measurement module 250 comprises a non-transitory computer-readable medium forming a software-based module providing processing unit 244 with instructions to measure the content of files to be accessed pursuant to a file event command from a container and based upon individual container specific policies set forth in policy store 270. The measurement values, when taken, are stored by processing unit 244 in the file content field 58 of the respective file event entry 54. In other implementations, measurement module 250 may comprise an integrated circuit-based module or combinations of a software-based module and the circuit-based module.

Policy store 270 comprises a non-transitory computer-readable medium or memory that contains container specific IMA integrity policies. In the example illustrated, policy store 270 may comprise a table or a series of entries that map particular policies, policies A (272-1), B (272-2) . . . 272-N) (collectively referred to as policies 272) to particular name spaces in namespace fields 274-1, 274-2, . . . 274-n. The container specific IMA integrity policies 272 define what files are to be measured, audited and appraised on a container-by-container basis. For example, a container verification policy store may comprise or store a policy 272-1 that directs a file to be measured for the IMA log, such as the generation of a hash of the contents of the file for the IMA log, when the file is being accessed by a first container, such as container 30-1. The container verification policy store 270 comprises or stores a policy 272-2 that directs the same file is not to be measured for the IMA log when being accessed by second different container comes such as container 30-2. In some implementations, the container verification policies 272 may additionally vary depending upon the type of access to the file being requested by a particular container. As a result, each process running inside of its respective container 30 may follow its own IMA policy, completely independent of other processes running inside of other respective containers 30.

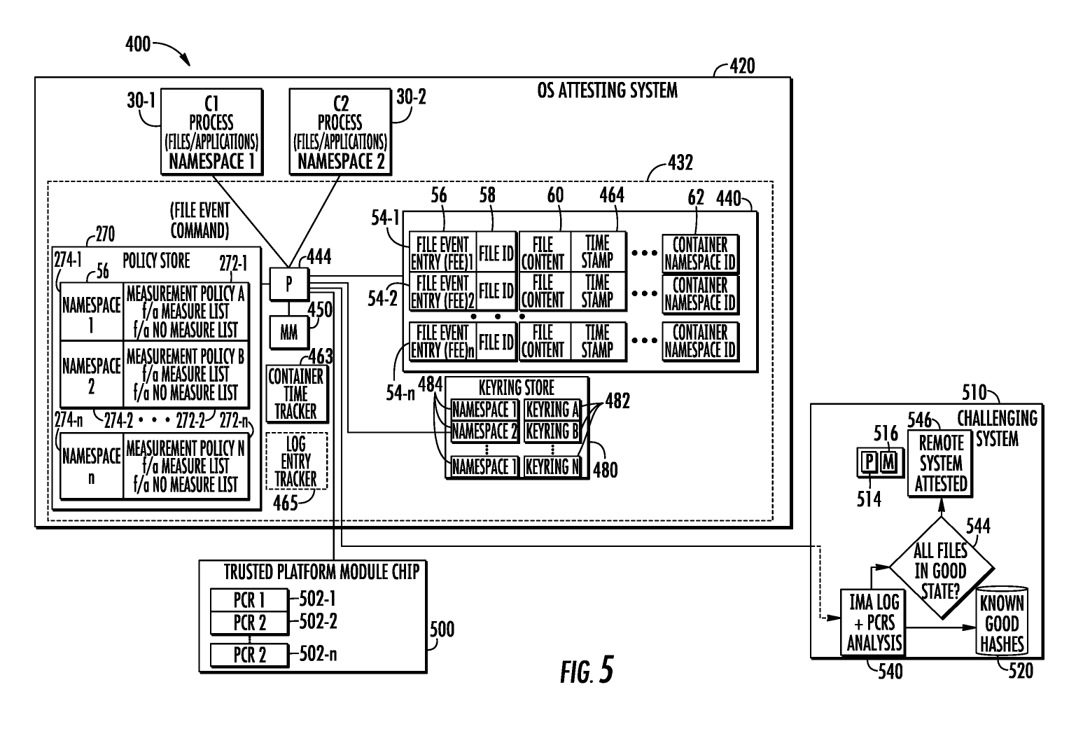

FIG. 4 is a flow diagram of an example trusted computing IMA security method 300 that may be carried out by system 20. Method 300 utilizes container-specific IMA security policies to determine whether files being accessed pursuant to a file event command from the container are to be measured. Although method 300 is described in the context of being carried out by system 220, it should be appreciated that method 300 may likewise be carried out with any of the disclosed systems or by similar systems.

As indicated by block 304, integrity subsystem 232 receives a command (file event command) to carry out an event for a container, such as from container 30-2, with respect to a file of the container. The container is identified by a container namespace.

As indicated by block 308, in response to integrity subsystem 232 receiving the command, measurement module 250 may direct processing unit 244 to consult policy store 270 regarding the container from which the file event command originated. In particular, measurement module 250 directs processing unit 244 to access a lookup table of policy store 270, wherein the lookup table comprise different measurement policies (IMA security or integrity policies) for different containers, such as for containers 30.

As indicated by block 312, measurement module 250 directs processing unit 244 to retrieve a measurement policy for the particular container from which the file event command was originated. For example, in response to the file event command being received from container 30-1 having namespace 1, measurement module 250 may direct processing unit 244 two access policy A (272-1) which is map to namespace 1 in the corresponding field 274-1. Processing unit 244 retrieves measurement policy A (272-1).

As indicated by block 316, measurement module 250 follows the rules or instructions provided in the retrieve measurement policy. In response to the file/application (f/a) being accessed pursuant to the file event command received from the container being part of a “measure list”, processor 244 measures the content of the file to produce a measurement value. In one implementation, such measurement may be the application of a hash to the contents of the file. In some implementations, the measured value is then stored in the file content field 60 of IMA log 240 for the respective file event entry 54. In response to the file/application (f/a) being accessed pursuant to the file event command received from the container being part of a “no measure list”, processor 244 does not measure the content of the file.

FIG. 5 schematically illustrates portions of an overall trusted computing IMA security system 400. System 400 comprises an operating system attesting system 420 (in the form of a Linux operating system integrity subsystem kernel) that combines aspects from both of systems 20 and 220 in that system 420: (a) stores a container namespace ID in the file event entries of the IMA log, indicating the container from which the file event command that triggered the file event entry originated (as described above with respect to system 20) and (b) measures files to be accessed pursuant to a file event command from a container based upon container-specific measurement or IMA security policies (as described above with respect to system 220). System 420 further (a) facilitates the specific association of a container with a particular field event entry using the container namespace despite the use of the namespace by multiple containers and (b) provide for container specific key rings to facilitate container-specific security measures. System 400 comprises operating system attesting system 420, TPM chip 500 and remote challenging system 510.

Operating system attesting system 420 comprises containers 30 (described above with respect to system 20) and integrity subsystem 432. Integrity subsystem 432 comprises IMA log 440, processing unit 444, measurement module 450, container time tracker 463, policy store 270 (described above with respect to system 220) and key ring store 480. IMA log 440 is similar to IMA log 40 described above except that IMA log 440 is additionally illustrated as comprising a timestamp field 464 in each of entries 54. Timestamp field 464 comprise a memory field for storing a timestamp value based upon the time of the file event command or the file event entry. As will be described hereafter, the timestamp field 464 facilitates identifying which container was associated with the particular namespace at the time of the file event command or file event entry for the particular file event entry 54.

Measurement module 450 is similar to measurement module 50 and 250 described above. Similar to measurement module 50, measurement module 450 may carry out method 100. Measurement module 450 stores the namespace of the container from which a file event command originated in the container namespace ID field 62 of the IMA log of the file event entry that was triggered by the file event command from the container. Measurement module 450 additionally records or stores a timestamp value in timestamp field 464 of IMA log 440 for each file event entry 54. The timestamp value may be based upon the time of the file event command or the file event entry.

Similar to measurement module 250, measurement module 450 may carry out method 300. Measurement module 450 measures (or does not measure) the file of a file event command based upon container-specific policies provided in policy store 270.

Container time tracker 463 comprises a module that directs processing unit 440 to track a period of time during which containers 30 are identified by respective name spaces and to store such tracked information in an associated memory. For example, a particular namespace may be utilized to identify a first container during a first period of time. Upon expiration or termination of the first container, the same namespace may then be reused to identify a second different container during a second period of time. Container time tracker 463 keep track of such times. During subsequent auditing of IMA log 440, a particular file event entry 54 may be mapped to a particular container using the timestamp value in field 464 of the file event entry 54 and data from container time tracker 463 indicating the period of time during which a particular namespace was assigned to a particular container. In such a manner, the particular container from which a particular file event originated may be identified despite sequential usage of a particular namespace ID by multiple containers.

As illustrated by broken lines, in some implementations, integrity subsystem 432 may additionally or alternatively comprise a log entry tracker 465. Log entry tracker 465 directs processing unit 444 to track (and store in a non-transient memory) the number of file events in the IMA log when a particular container is started. In such a system, a record indicating the number of file events initiated by the container may be kept for each of containers 30. In such a manner, the particular container from which a particular file event originated may be identified despite usage of a particular namespace ID by multiple containers.

Key ring store 480 assigns key rings in a container-specific manner. The IMA system may support digital signatures for immutable files, storing the digital file signature along with the file hash grading the digital signal may involve generating an RSA private/public key pair. The key generation may be anchored on a trusted platform module (TPM) and stored in kernel memory using a key storage mechanism called a key ring. Different containers 30 may utilize different sets of keys, different or separate key rings for 482 for each namespace 484. Because each container or namespace ID for 484 (associated with respective containers 30) may be assigned a distinct IMA policy (per above) digital file signature usage may be specific per container 30.

Trusted platform module chip 500 comprises an tamper-resistant chip or other memory location which stores integrity or security information such as platform configuration registers (PCRs) 502-1, 502-2, . . . 502-n (collectively referred to as PCR's 502). The PCR cannot be reset while the system is running, it is only possible to “extend” the current value with a new hash. The TPM 500 combines the new hash with the existing PCR value to create a new value which is stored in the PCR. In this way the old value cannot erased.

Remote challenging system 510 comprises a processing unit 514 and an associated non-transitory computer-readable medium in the form of a memory 516. Remote challenging system 510 may additionally comprise or may be connected to a separate valid file hash database 520 in a wired or wireless fashion. In one implementation, remote challenging system 510 communicates with the valid file hash database 520 (also referred to as the “known good hashes”) across a network. Remote challenging system 510 performs integrity checks and auditing of system 420. Remote challenging system 510 first confirms the integrity of the current IMA log 440. Remote challenging system 510 further audits the integrity of the files used by the containers 32 identify operating system attacks or unauthorized file or IMA log alterations.

In operation, measurement module 450 or an alternative module directs processing unit 440 to create a hash of each file event log entry, as the file entries are being made in the IMA log 440. The hash of the file event log entry is communicated to the TPM chip 500 which stores the hash of the file event log entry as a PCR. As discussed above, the PCR cannot be reset while the system is running, it is only possible to “extend” the current value with a new hash. The TPM chip 500 combines the new hash with the existing PCR value to create a new value which is stored in the PCR. In this way the old value cannot erased.

The remote challenging system 510 asynchronously verifies the accuracy or integrity of the current IMA log 440 and the files identified in the IMA log 440. On a periodic or undefined basis, the remote challenging system receives the PCR values 502 from the TPM chip 500 and also receives the current IMA/TPM log 440. As indicated by block 540, the remote challenging system 510 analyzes the IMA log 440 and the PCRs 502 by comparing the PCR values with respect to the IMA log entries to verify the integrity of the current IMA/TPM log 440. In particular, in one implementation, the remote challenging system 510 performs the same hash on each entry of the current IMA/TPM log 440 as was additionally applied during the generation of the PCR values stored on the TPM chip 500. The remote challenging system 510 compares the PCR values from the TPM chip 500 to the hashed file event entries of the current IMA log 440 to confirm or verify integrity of the current IMA log 440.

Upon verification of the IMA log 440, the remote challenging system 510 compares the measurement values for the file in each of the file event entries 54 of the IMA log 440 to predefined or predefined measurement values for valid versions of the same file. As indicated by block 544, the remote challenging system 510 compares the measurement value contained in file content field 60 of each file event entry 54 to the “known good hash” for a valid version of the same file. The hashes of the “known good hashes” are the same hashes as applied to the file content as stored in the file event entry of the IMA log 440. A file event entry 54 in log 440 having a file content measurement value (hash value) in field 60 that matches the file content measurement value (hash value) of a valid version of the file stored or retrieved by the remote challenging system 510 from database 520 may be deemed to be uncorrupted or as having integrity. As indicated by block 546, system 420 may be attested where the IMA log 440 has integrity and where each of the files in the IMA log 440 have integrity (the hash values of the files in fields 60 match the hash values of the corresponding files in database 520).

In contrast, a file event entry 54 in log 440 having a file content measurement value (hash value) in field 60 that does not match the file content measurement value (hash value) of a valid version of the same file stored or retrieved by remote challenging system 510 from database 520 may be deemed to have been corrupted. The stored name spaces in the container namespace ID field 62 in the IMA log 440 may then be utilized by the attesting system, the remote challenging system or other integrity auditing systems to identify the container 30 where the particular file may have been attacked or corrupted.

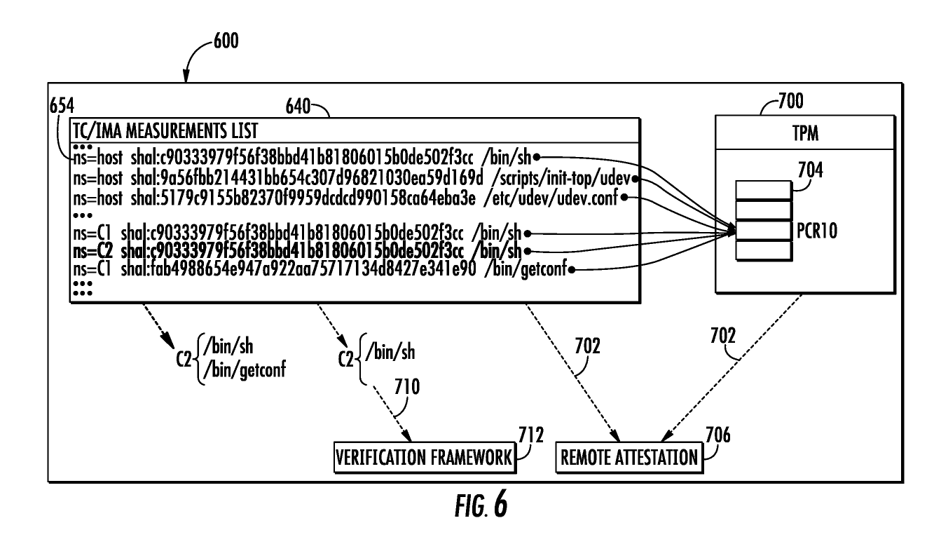

FIG. 6 illustrates portions of an example trusted computing integrity measurement architecture system 600, illustrating IMA log 640 and portions of an example TPM chip 700. In the first stage of the remote attestation process 706, the IMA log is validated by sending the log's entries and the signed PCRs 702 to the remote challenging system 510 which virtually reproduces the history of PCR extensions until the last log entry 654. (shown in FIG. 5). The result value must match the reported PCR value. Once the IMA log is validated, as indicated by arrow 710, each hashed file content may be transmitted to verification framework 712 for comparison to “known good hashes” to verify the integrity of the files that may have been utilized by the containers.

Although the present disclosure has been described with reference to example implementations, workers skilled in the art will recognize that changes may be made in form and detail without departing from the spirit and scope of the claimed subject matter. For example, although different example implementations may have been described as including features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A trusted computing integrity measurement architecture (IMA) security method comprising:
receiving a command to carry out an event for a container with respect to a file of the container, the container being identified by a namespace;
measuring the file to produce a measurement value for the file; and
storing the measurement value, an identification of the file and the namespace in an entry of an IMA log.

2. The method of claim 1, wherein the identification of the file comprises a pathname for the file and wherein the measurement value comprises a hash of content of the file.

3. The method of claim 1 further comprising:
tracking a period of time during which the container was identified by the namespace; and
storing a timestamp value for the measuring in the entry of the IMA log.

4. The method of claim 1 further comprising tracking a number of IMA log entries during a life of the container.

5. The method of claim 1 further comprising, prior to the measuring of the file, retrieving a measurement policy for the container, wherein the measuring of the file is in accordance with the measurement policy.

6. The method of claim 1 further comprising, prior to the measuring of the file:
accessing a lookup table, the lookup table comprising different measurement policies for different containers; and
retrieving a measurement policy for the container, wherein the measuring of the file is in accordance with the measurement policy.

7. The method of claim 6, wherein the different measurement policies for different containers comprise:
instructions to measure the file in response to the event being carried out for the container; and
instructions to not measure the file in response to the event being carried out for a second container.

8. The method of claim 1 further comprising, for cryptographically signed container files:
accessing a lookup table, the lookup table comprising a different keyring for each of different containers; and
retrieving cryptographic keys for the container in order to verify container file signatures.

9. A trusted computing integrity measurement architecture (IMA) security method comprising:
receiving a command to carry out an event for a container with respect to a file of the container, the container
accessing a lookup table, the lookup table comprising different measurement policies for different containers, wherein the different measurement policies for different containers comprise:
instructions to measure the file in response to the event being carried for the container; and
instructions to not measure the file in response to the event being carried out for a second container; and
retrieving a measurement policy for the container; and
measuring content of the file is in accordance with the measurement policy to produce a measurement value.

10. The method of claim 9 further comprising storing the measurement value, an identification of the file and the namespace in an entry of an IMA log.

11. The method of claim 10, wherein the identification of the file comprises a pathname for the file and wherein the measurement value comprises a hash of content of the file.

12. The method of claim 10 further comprising:
tracking a period of time during which the container was identified by the namespace; and
storing a timestamp value for the measuring in the entry of

13. The method of claim 10 further comprising tracking a number of IMA log entries during a life of the container.

14. A trusted computing integrity measurement architecture (IMA) security system comprising:
containers, each container comprising a process built upon containerized files and designated by a namespace;
an integrity measurement architecture log comprising file event entries, each entry comprising a file identification field, a file content field and a namespace field;
a processing unit;
a measurement module comprising a non-transitory computer-readable medium containing instructions to direct the processing unit to:
receive a command to carry out an event for one of the containers with respect to a file of the container;
measure the file to produce a measurement value for the file; and
store the measurement value, an identification of the file and the namespace in an entry of an

15. The system of claim 14, further comprising a key ring store, the key ring store storing a key ring for each of the containers for the system to verify a container file signature.

16. The system of claim 14, wherein the identification of the file comprises a pathname for the file and wherein the measurement value comprises a hash of the content of the file.

17. The system of claim 14 further comprising:
a container tracking module to direct the processing unit to track a period of time during which the container was identified by the namespace, wherein the verification module is to store a timestamp value for the measuring in the entry of the IMA log.

18. The system of claim 14 further comprising a container log entry tracker to track a number of IMA log entries during a life of the container.

19. The system of claim 14 further comprising a stored container verification policy, the container verification policy comprising different measurement policies for different containers.

20. The system of claim 19, wherein the different measurement policies for different containers comprise:
instructions to measure the file in response to the event being carried for the container; and
instructions to not measure the file in response to the event
